(19) United States
(12) Patent Application Publication
(10) Pub. No.: US 2026/0338249 A1
(43) Pub. Date: Oct. 29, 2026

(54) DAMPING-VALVE DEVICE FOR A VIBRATION DAMPER OF A MOTOR VEHICLE

(71) Applicants: thyssenkrupp Bilstein GmbH, Ennepetal (DE); thyssenkrupp AG, Essen (DE)

(72) Inventors: Christoph SCHMIDT, Bonn (DE); Karim Mohamed EL KHAWAGA, Koeln (DE)

(73) Assignees: thyssenkrupp Bilstein GmbH, Ennepetal (DE); thyssenkrupp AG, Essen (DE)

(21) Appl. No.: 19/659,862

(22) Filed: Apr. 27, 2026

(30) Foreign Application Priority Data
Apr. 28, 2025 (DE) 10 2025 116 128.3

(51) Int. Cl. F16F 9/34; F16F 9/18; F16F 9/36

(52) U.S. Cl. CPC F16F 9/34; F16F 9/185; F16F 9/369; F16F 2222/12; F16F 2224/02; F16F 2226/04; F16F 2226/042; F16F 2230/30; F16F 2232/08; F16F 2234/02

(57) ABSTRACT

A vibration damper of a motor vehicle comprises an outer tube and an inner tube arranged so as to be coaxial therewith, and a working piston which is arranged so as to be axially movable within the inner tube and which divides the interior space of the inner tube into a piston-rod-side working chamber and a piston-rod-remote working chamber, a damping-valve device which is arranged in the working piston, wherein the damping-valve device has: a damping-valve housing, a coil unit which is arranged within the damping-valve housing and which has a coil carrier and a coil wound thereon, and a separating element for sealing off the coil unit in relation to the damping-valve housing, and an armature chamber which is arranged within the coil unit and in which an axially movable armature is arranged, wherein the separating element is formed from a plastic.

### CROSS REFERENCE TO RELATED APPLICATION

This application is a U.S. Non-Provisional that claims priority to German Patent Application No. DE 10 2025 116 128.3, filed Apr. 28, 2025, the entire content of which is incorporated herein by reference.

### FIELD

The present disclosure relates to a damping-valve device for a vibration damper for motor vehicles, wherein the damping-valve device has a main valve and a pilot valve.

### BACKGROUND

DE 10 2020 215 480 A1 has disclosed a vibration damper having a damping-valve device, wherein the damping-valve device has a pilot valve or main valve which is settable via a magnet coil. During operation of the damping-valve device, a gas chamber is formed within the housing part in which the magnet coil is arranged, said gas chamber requiring continuous venting.

Thus a need exists to provide a damping-valve device for a vibration damper in which the damping-valve device is vented in a low-cost and structurally simple manner.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a schematic illustration of a vibration damper in a longitudinal sectional view according to an exemplary embodiment.

FIG. 2 shows a schematic illustration of a detail of the damping-valve device of a vibration damper in a longitudinal sectional view according to an exemplary embodiment.

FIG. 3 shows a schematic illustration of a coil unit of the damping-valve device in a longitudinal sectional view and in a perspective view according to an exemplary embodiment.

FIG. 4 shows a schematic illustration of a coil unit of the damping-valve device in a longitudinal sectional view and in a perspective view according to a further exemplary embodiment.

FIG. 5 shows a schematic illustration of a flux plate of a damping-valve device according to an exemplary embodiment.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

According to a first aspect, a vibration damper of a motor vehicle comprises an outer tube and an inner tube arranged so as to be coaxial therewith, and a working piston which is arranged so as to be axially movable within the inner tube and which divides the interior space into a piston-rod-side working chamber and a piston-rod-remote working chamber. In the working piston, there is arranged a damping-valve device which has a damping-valve housing, a coil unit which is arranged in said damping-valve housing and which has a coil carrier and a coil wound thereon, and a separating element for sealing off the coil unit in relation to the damping-valve housing and/or for separating hydraulic oil and gas within the damping-valve housing, in particular the coil unit. Provision is made within the coil unit of an armature chamber in which an axially movable armature is mounted. The separating element is advantageously formed from a plastic. In particular, the separating element consists entirely of a plastic.

It is particularly advantageous that the separating element is producible from a plastic in a very simple manner and at low cost in large unit quantities. As a result of the formation of the separating element from a plastic, it is particularly simple to integrate additional structures or channels that serve for venting or passage of fluid. The separating element is preferably designed as a hollow-cylindrical component with an open or closed base, such as to at least partially surround the armature chamber.

The damping-valve device is for example a pressure-limiting valve, which can preferably be pilot-controlled or directly controlled. A damping-valve device designed as a pilot-controlled pressure-limiting valve preferably, in addition to a main valve, comprises a pilot valve, having a pilot working chamber and a sliding plunger which is arranged in the pilot working chamber and is axially movable by means of the armature, and a connecting channel, which is arranged between the pilot control chamber and the pilot working chamber and fluidically connects these to one another. The main valve with the main piston is preferably configured for closing and opening the damping-valve device, in particular the pressure-limiting valve. The main piston is preferably axially movable by means of the armature and/or the hydraulic pressure prevailing in the pilot control chamber.

The pilot control chamber is to be understood as being the hydraulic chamber which is preferably directly adjacent to the main piston and which preferably subjects this to a hydraulic force in the closing direction of the main valve. The pilot control chamber is preferably arranged on the main piston so as to be situated opposite the rebound main control chamber and the compression main control chamber. For example, the main piston is designed in such a way that that end face of the main piston which faces toward the compression main control chamber or the rebound main control chamber and which is subjected to the hydraulic pressure of the compression main control chamber or the rebound main control chamber is larger than that end face of the main piston which faces toward the pilot control chamber and which is subjected to the hydraulic pressure of the pilot control chamber.

The damping-valve device is arranged for example in a vibration damper for a motor vehicle. The vibration damper is for example a single-tube vibration damper or a multi-tube vibration damper, by way of example a twin-tube vibration damper. The vibration damper comprises for example an outer tube which forms an outer surface, in particular a housing, of the vibration damper. An inner tube, which is also referred to as a damper tube, is arranged within the outer tube so as to be coaxial with the latter. A compensation chamber, which is preferably filled at least partially with a hydraulic fluid, is formed between the outer tube and the inner tube. For example, the compensation chamber is filled partially with a gas.

Preferably, a working piston connected to a piston rod is arranged within the inner tube in such a way as to be movable within the inner tube, wherein the inner tube is preferably formed as a guide of the working piston. A damping-valve device is arranged on the working piston, for example. The working piston divides the interior space of the inner tube in particular into a first, piston-rod-side working chamber and a second, piston-rod-remote working chamber.

The vibration damper preferably has a closure package which fluidically seals off the interior space of the outer tube at the piston-rod side. Opposite the closure package, at the piston-rod-remote end, the interior space of the outer tube is preferably sealed off fluidically by means of a base piece. A base valve, which is mounted on the piston-rod-remote end of the inner tube, is in particular arranged on the base piece.

The damping-valve device comprises a preferably cylindrical damping-valve housing, which is a substantially tubular damping-valve housing, and a housing top part, which is mounted on the damping-valve housing or is formed as a single part therewith. By way of example, the damping-valve housing has a connection region having one or more connection contacts for an electrical current supply of the damping-valve device. The connection contacts for an electrical current supply are preferably connected to a drive unit.

The damping-valve device preferably has a drive in the form of an electromagnet, in particular a coil unit which has a coil with a plurality of windings made of a current-conducting wire. The coil unit is preferably arranged within a housing of the damping-valve device and comprises for example a coil carrier on which the windings of the coil are wound. Preferably, the coil at least partially or completely surrounds an armature chamber which extends centrally in an axial direction. An armature is preferably mounted in an axially movable manner within the armature chamber. The armature is preferably attached so as to be slidable in the axial direction within the armature chamber, and a central armature rod which, by way of example, is of tubular form and extends centrally through the armature chamber in the axial direction is comprised for example by said armature. The armature chamber is preferably delimited by an at least partially hollow-cylindrical pole tube which preferably serves as a guide for the armature.

The coil is preferably designed and arranged in such a way that, upon electrical energization, it forms a magnetic field having magnetic-field lines that extend, preferably substantially in the axial direction, in the armature chamber. The armature is preferably formed from a magnetizable or magnetic material and movable in the axial direction according to the magnetic field formed by means of the coil.

The pole tube has in particular an upper tubular region with an in particular constant inner diameter, which is preferably in the form of a hollow cylinder and extends by way of example from the separating element to beyond the armature in the axial direction. The upper hollow-cylindrical region is adjoined in the axial direction by a lower region of increased diameter, wherein the outer surface of the pole tube preferably extends to the damping-valve housing and lies at least partially against the latter and is sealed off in a fluid-tight manner, via for example a sealing ring, in relation to the damping-valve housing. The damping-valve housing at least partially or completely surrounds the valve region (not illustrated) in the axial direction and in the circumferential direction. The pole tube is in particular of multi-part, integral or single-part form. Below the pole tube, in particular in a compression direction D, there adjoins a working chamber, which is for example in the form of a pilot working chamber.

The damping-valve device optionally comprises a main valve and a pilot valve. The pilot valve is preferably arranged behind the main valve in the flow direction both in the compression stage and in the rebound stage of the vibration damper. In particular, the damping-valve device is able to be flowed through by hydraulic fluid in both directions. Preferably, the damping-valve device arranged in the working piston has exactly one main valve and/or exactly one pilot valve. Mounted for example on the working piston is a seal, in particular a sealing ring, which seals off the working piston in a fluid-tight manner in relation to the damper tube.

Furthermore, the damping-valve device optionally has a comfort valve. The comfort valve is preferably configured such that it is able to be flowed through by hydraulic fluid both in the compression direction and in the rebound direction. The comfort valve comprises in particular at least one comfort-spring-disk package, which for example comprises at least one or a plurality of spring disks that lie on a comfort-valve seat. The comfort valve is, fluidically, connected preferably directly to the piston-rod-remote working chamber. Preferably, the comfort valve is arranged in the piston-rod-remote working chamber and forms in particular that end of the working piston which points in the direction of the base valve.

During operation of the damping-valve device and in the case of a movement of the piston rod in the compression direction, the hydraulic fluid preferably flows from the piston-rod-remote working chamber into the optional comfort valve into the compression main control chamber, wherein, due the pressure in the compression main control chamber, the main piston is subjected to an opening force and is moved axially upward. In the process, the main piston lifts off from the main-valve seat and the hydraulic fluid flows through the main flow channel to the rebound main control chamber, in particular to the second fluid passage, and subsequently into the piston-rod-side working chamber. At the same time, in particular hydraulically parallel thereto, a partial stream of the hydraulic fluid flows into the pilot control chamber and subjects the main piston to a closing force in the direction of the main-valve seat. The closing force determines the opening width of the main valve, which determines the damping force of the damping-valve device. The pressure in the pilot control chamber is preferably set by the pilot valve, wherein the hydraulic fluid flows from the pilot control chamber through the connecting channel into the pilot working chamber, which is opened up by the sliding plunger. The opening width, in particular the outflow cross section, of the connecting channel is preferably dependent on the axial position of the sliding plunger, which is set by means of the magnet coil. In the closed position of the pilot valve, the sliding plunger closes off the connecting channel preferably completely, so that the hydraulic pressure in the pilot control chamber increases to a maximum value and the main valve is closed in that the main piston is pressed onto the main valve seat. In an open position of the pilot valve, the connecting channel is opened up at least partially by the sliding plunger.

According to a first embodiment, the separating element is produced by means of an injection-molding process. The injection-molding process makes it possible to achieve precise shaping, which is relevant in particular for sealing surfaces and fits. By using an injection-molding process to produce the separating element, it is possible to realize for example undercuts or fastening extensions at the separating element without cumbersome rework. For high temperature resistance or high chemical resistance, consideration can be given to different plastics which can be adapted to specific applications. For example, the separating element is formed from one of the following plastics: PPS (polyphenylene sulfide), PEEK (polyether ether ketone), PPSU (polyphenylsulfone) or PSU (polysulfone), PVDF (polyvinylidene fluoride), PEI (polyetherimide), PES (polyethersulfone).

The separating element is arranged between the coil, in particular the coil carrier, and the damping-valve housing in the axial direction and preferably in this case at least partially delimits a central armature chamber. For example, the separating element has a hollow-cylindrical form which is open in particular in the direction of the main valve and which, preferably, lies against the inner surface of the damping-valve housing in a radial direction, in particular in a fluid-tight manner. By way of this arrangement, preferably, on the one hand, the interior of the armature chamber is sealed off in relation to outer fluid regions and, on the other hand, a region for venting or for a fluid stream serving for venting is provided without the need for additional connection elements.

According to a further embodiment, the separating element has a fluid channel which extends in a radial direction and which has a round or polygonal cross section and which is connected fluidically to the armature chamber. A radial fluid channel facilitates venting of the armature chamber and ensures targeted throughflow, so that air pockets are removed quickly. The channel cross section varies for example according to the desired throughflow rate and is configured to be for example polygonal for relatively large flow rates or round for uniform flows. The fluid channel can be integrated directly into the separating element by means of the injection-molding process, which saves on additional components and simplifies assembly. The fluid channel extends preferably completely in the radial direction and opens out in particular into the upper end of the armature chamber. A gas, in particular air, accumulates at the upper end, pointing in the direction of the closure package, of the armature chamber during operation of the vibration damper. The fluid channel opens out into the armature chamber preferably at the axially highest position, so that the gas can preferably be conducted completely out of the armature chamber.

According to a further embodiment, the damping-valve housing has a radially extending bore which is connected fluidically to the fluid channel and whose diameter is greater than the diameter of the fluid channel. A relatively large bore in the damping-valve housing simplifies manufacture and at the same time allows the actual flow cross section in the separating element to be defined. For example, additional elements such as filters or valve inserts are integrable in such a bore according to requirement. The relatively small diameter in the separating element can bring about flow throttling, which is advantageous for fine-tuning the damping properties.

The bore and the fluid channel are preferably arranged at the same axial height and in particular so as to be aligned with one another. For example, the fluid channel opens out directly into the bore or a fluid chamber is formed between the fluid channel and the bore.

According to a further embodiment, the diameter of the fluid channel corresponds to 1.5 to 5 times, in particular 2 to 3 times, the diameter of the bore. Preferably, the ratio between fluid-channel diameter and bore diameter is adapted according to the viscosity of the hydraulic fluid used, the pressure level and/or the temperature. According to a finding by the inventors, the specified ratio of the diameters ensures optimum venting of the armature chamber and reliably prevents formation of noise.

According to a further embodiment, the separating element is bonded substance-to-substance to the coil carrier. Preferably, the separating element is bonded to the coil carrier by adhesive bonding, welding or overmolding. In this way, a durable and firm connection between the coil carrier and the separating element that avoids gaps and leaks is achieved. Substance-to-substance bonding moreover reduces the need for additional fastening elements and increases installation-space efficiency. Due to the firm, substance-to-substance bonding, the separating element remains in a stable position even under changing temperatures and vibrations, and noise during operation of the vibration damper is avoided.

According to a further embodiment, the separating element is connected directly to the coil carrier by means of an injection-molding process. The coil carrier is preferably placed into the injection-molding tool so that the separating element to be produced by means of the injection-molding process adheres to the coil carrier in one working step. Such an injection-molding process is inexpensive and simple to carry out. Moreover, an injection-molding process makes it possible to form complex geometries, such as grooves or channels, by means of the injection-molding process and to thereby save on further reworking steps, which further simplifies the production. The coil carrier and the coil are preferably overmoldedby means of the injection-molding process.

According to a further embodiment, a flux plate is situated between the coil carrier and the separating element. The flux plate serves to conduct the magnetic flux generated by the coil and to form a magnetic circuit together with the armature, the pole tube and the valve housing. The flux plate is for example of ring-shaped or disk-shaped form, in particular the flux plate is of circular-ring-disk-shaped form. The flux plate preferably lies directly against the pole tube, the damping-valve housing and, in particular, the coil carrier. The flux plate, the pole tube, the damping-valve housing, the coil and the armature are preferably configured and arranged in such a way as to form a magnetic circuit.

The flux plate preferably serves for targeted direction of the magnetic field and is in particular positioned in such a way as to effectively influence the magnetic flux of the coil and to align it in particular with the armature. The flux plate preferably has apertures, holes or cutouts in order to make possible in particular improved fastening in an overmolding process.

The flux plate preferably has a plurality of cutouts which extend in particular completely axially through the thickness of the flux plate and which, for example, are in the form of slots. Preferably, the cutouts serve for fastening of the flux plate to the separating element, which is in particular molded onto the flux plate by means of an injection-molding process. The flux plate preferably has at its outer circumference a recess which, optionally, is of rectangular form. The coil carrier preferably has an axial projection which extends along the recess and which, for example, serves for mounting of the coil carrier.

According to a further embodiment, the flux plate is formed from a magnetic or magnetizable material. Preferably, the flux plate consists entirely of a magnetic or magnetisable material. For example, the flux plate is formed from steel, in particular low-carbon steel, such as unalloyed structural steel, or ferritic stainless steel. A material of high magnetic permeability results in relatively low magnetic scattering losses, which increases the transmission of force to the armature.

According to a further embodiment, the flux plate is connected to the separating element by means of an injection-molding process. The flux plate is preferably placed into an injection-molding tool so that the plastic produces a reliable substance-to-substance bond during the casting operation. The cutouts in the flux plate or, optionally, structurings of the surface of the flux plate preferably promote the inflow of the plastic and the adhesion thereof to the flux plate. A one-part assembly composed of coil, coil carrier and flux plate preferably reduces possible contact corrosion and simplifies the mounting of the stated elements in the vibration damper.

According to a further embodiment, arranged circumferentially around the separating element are two sealing rings which lie against both the separating element and the inner side of the damping-valve housing, and wherein the fluid channel is arranged between the sealing rings. The outer diameter of the separating element is preferably smaller than or corresponds to the inner diameter of the damping-valve housing, so that the separating element lies against the damping-valve housing or a small gap is formed between the damping-valve housing and the separating element. In particular, the separating element has on its outer circumference two circumferentially extending grooves in which in each case one of the sealing rings is arranged. The fluid channel preferably extends between the sealing rings. The fluid channel preferably opens out at the circumferential outer surface of the separating element at a position between the two sealing rings. The sealing rings are for example of identical form and are arranged in particular so as to be coaxial with one another.

The arrangement of the sealing elements gives rise to a defined zone between the two sealing rings, in which defined zone a radially extending flow channel adjoined by the fluid channel is situated. This arrangement ensures that the hydraulic fluid does not flow past the separating element in an uncontrolled manner, but is conducted in a targeted manner via the fluid channel provided. The clearances at the separating element ensure that the sealing rings are reliably held in position, so as to ensure a permanently tight connection under changing operating conditions.

According to a further embodiment, a fluid chamber is provided between the bore and the fluid channel and is formed by a clearance in the separating element. Said fluid chamber preferably serves as a calming or collecting volume in which for example enclosed gases accumulate and are removed in a targeted manner. The clearance is preferably formed at the outer side of the separating element. Preferably, the clearance is formed at the outer-side mouth of the fluid channel. The clearance is arranged in particular between the two sealing rings. The clearance is for example of circular or polygonal form, for example in order to adapt flow conditions or to attenuate peak pressures.

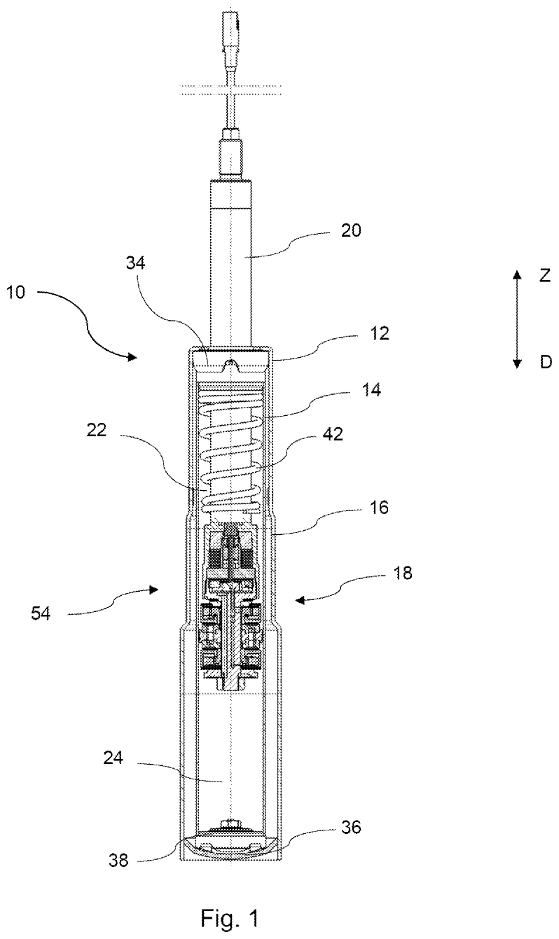

FIG. 1 shows a vibration damper 10, wherein the vibration damper 10 is a multi-tube vibration damper, by way of example a twin-tube vibration damper. The vibration damper 10 has an outer tube 12 which forms an outer surface, in particular a housing, of the vibration damper 10. An inner tube 14, which may also be referred to as a damper tube, is arranged within the outer tube 12 so as to be coaxial with the latter. A compensation chamber 16, which is preferably filled at least partially with a hydraulic fluid, is formed between the outer tube 12 and the inner tube 14. For example, the compensation chamber 16 is filled partially with a gas.

A working piston 18 connected to a piston rod 20 is arranged within the inner tube 14 in such a way as to be movable within the inner tube 14, wherein the inner tube is preferably formed as a guide of the working piston 18. The working piston 18 has a damping-valve device 54. The working piston 18 divides the interior space of the inner tube 14 into a first working chamber 22, which is arranged at the piston-rod side, and a second working chamber 24, which is arranged so as to be remote from the piston rod.

The interior space of the outer tube 12 is sealed off fluidically by means of a closure package 34 at the piston-rod side. Opposite the closure package 34, at the piston-rod-remote end, the interior space of the outer tube 12 is sealed off fluidically by means of a base piece 36. By way of example, a base valve 38, which is mounted in particular on the piston-rod-remote end of the inner tube 14, is arranged on the base piece 36. The base valve 38 is for example a check valve which is able to be flowed through in both directions or only in one direction. The second working chamber 24 is preferably connected fluidically to the compensation chamber 16 via the base valve 38. The piston-rod-side end of the inner tube 14 and of the outer tube 12 is preferably fastened to the closure package 34. The piston rod 20 has for example an optional rebound stop which, via a spring element 42, is subjected to spring force in the case of a movement in a rebound direction Z.

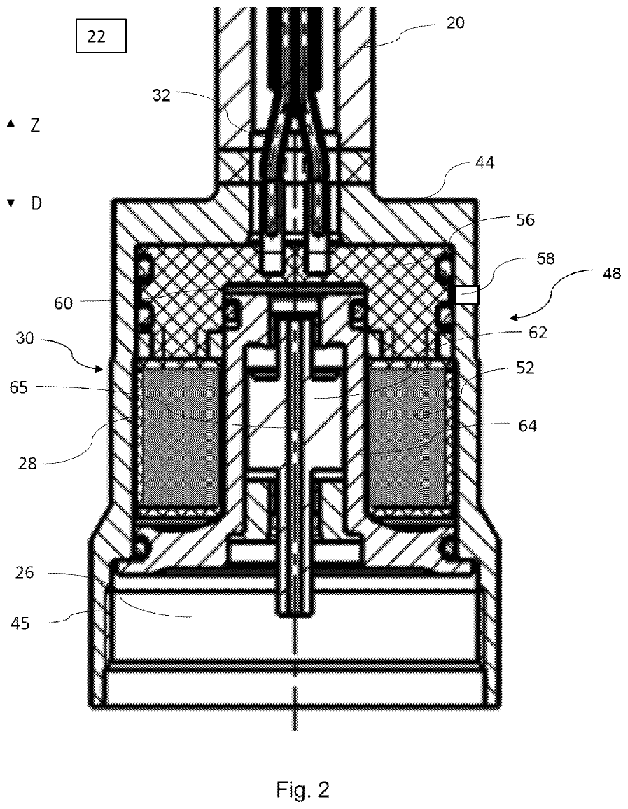

FIG. 2 shows an exemplary damping-valve device 54, which is preferably arranged in the working piston 18 of the vibration damper 10. The damping-valve device 54 is for example in the form of a pilot-controlled or directly controlled pressure-limiting valve and comprises a preferably cylindrical damping-valve housing 45, which by way of example is in the form of a substantially tubular damping-valve housing 45, and a housing top part 44, which for example is formed as a single part with the damping-valve housing 45. The piston rod 20 is preferably mounted on the housing top part 44. The housing top part 44 has for example a connection region (not illustrated) having one or more connection contacts for an electrical current supply of the damping-valve device 54. The connection contacts for an electrical current supply are preferably connected to a drive unit.

By way of example, the damping-valve device 54 has a drive region 48 and a valve region (not illustrated). The drive region 48 is by way of example arranged in the upper region, which is relatively close to the piston rod 20, of the damping-valve device 54, and preferably substantially above the valve region 50, in particular in the rebound direction Z. The drive region 48 preferably comprises a drive in the form of an electromagnet. The electromagnet comprises a coil unit 30 which has a coil 52 with a plurality of windings of a current-conducting wire. The coil wire is preferably formed from a conductive material which is coated with an insulating layer. The coil 52 is preferably arranged within the damping-valve housing 45 and so as to be concentric with the latter. By way of example, the coil 52 lies against the inner wall of the damping-valve housing 45. A separating element 56, by way of example, is arranged axially between the coil 52 and the housing top part 44. The coil 52 preferably lies against the separating element 56 and is in particular fastened thereto. The separating element 56 is formed for example from a plastic. The coil unit 30 comprises for example a coil carrier 28, on which the windings are, in particular the wire of the coil 52 is, wound, and the separating element 56. The coil 52 at least partially or completely surrounds an armature chamber 60 which extends centrally in an axial direction. An armature 62 is mounted in an axially movable manner within the armature chamber 60. The coil unit 30 also comprises by way of example a contact element 32 for establishing electrical contact with an external current source.

The armature 62 is preferably of cylindrical form and has a diameter which is slightly smaller than the diameter of the armature chamber 60, so that the armature 62 is preferably attached so as to be slidable in the axial direction. By way of example, a central armature rod 65 which, by way of example, has a round cross section and extends centrally through the armature chamber 60 in the axial direction is comprised by the armature 62. The armature rod 65 is preferably of tubular form. The armature chamber 60 is preferably delimited by an at least partially hollow-cylindrical pole tube 64. The pole tube 64 preferably has a base and is configured to be open in particular in the direction of the valve region. The pole tube 64 is preferably formed from a magnetizable or magnetic material and has for example a magnetic separation means (not illustrated).

The coil 52 is preferably designed and arranged in such a way that, upon electrical energization, it forms a magnetic field having magnetic-field lines that extend, preferably substantially in the axial direction, in the armature chamber 60. The armature 62 is preferably formed from a magnetizable or magnetic material and movable in the axial direction according to the magnetic field formed by means of the coil 52.

The pole tube 64 has an upper tubular region with an in particular constant inner diameter, which is preferably in the form of a hollow cylinder and extends by way of example from the separating element 56 to beyond the armature 62 in the axial direction. The upper hollow-cylindrical region is adjoined in the axial direction by a lower region of increased diameter, wherein the outer surface of the pole tube 64 preferably extends to the damping-valve housing 45 and lies at least partially against the latter and is sealed off in a fluid-tight manner, via for example a sealing ring, in relation to the damping-valve housing 45. The damping-valve housing 45 at least partially or completely surrounds the valve region (not illustrated) in the axial direction and in the circumferential direction. The pole tube 64 is in particular of multi-part, integral or single-part form. Below the pole tube 64, in particular in a compression direction D, there adjoins a working chamber, which is for example in the form of a pilot working chamber 26.

The valve region (not illustrated) comprises for example a main valve and, optionally, a pilot valve. Preferably, the main valve and/or the pilot valve are/is able to be flowed through by hydraulic fluid in the case of a movement of the piston rod in the rebound direction Z and in the compression direction D. Preferably mounted on the working piston 18 is a seal, such as for example a sealing ring, which seals off the working piston 18 in a fluid-tight manner in relation to the damper tube 14. The seal preferably lies against the outer surface of the working piston 18, and against the inner surface of the damper tube 14, in a fluid-tight manner. Furthermore, the damping-valve device 54, in particular the valve region (not illustrated), optionally has a comfort valve. The comfort valve is preferably configured such that it is able to be flowed through by hydraulic fluid both in the compression direction D and in the rebound direction Z. The comfort valve comprises in particular at least one comfort-spring-disk package, which for example comprises at least one or a plurality of spring disks that lie on a comfort-valve seat. The comfort valve is, fluidically, connected preferably directly to the piston-rod-remote working chamber 24. Preferably, the comfort valve is arranged in the piston-rod-remote working chamber 24 and forms in particular that end of the working piston 18 which points in the direction of the base valve 36.

During operation of the damping-valve device 54, in the case of a piston-rod movement in the rebound direction Z, the hydraulic fluid preferably flows into the main valve and into the pilot valve and subsequently optionally through the comfort valve. The main valve preferably comprises a main piston which is arranged so as to be axially movable within a main working chamber. The main piston divides the main working chamber preferably into a compression main control chamber, a rebound main control chamber and a pilot control chamber. The hydraulic pressure of the second, piston-rod-remote working chamber 24 preferably prevails in the compression main control chamber, wherein the pressure of the first, piston-rod-side working chamber 22 preferably prevails in the rebound main control chamber.

In the open position of the main valve, there is formed between the main piston and a main-valve seat a main flow channel which forms a fluidic connection between the first and second working chambers 22, 24.

The pilot valve comprises in particular a sliding plunger which is arranged so as to be axially movable within the pilot working chamber 26. The sliding plunger (not illustrated) preferably lies at its end remote from the main valve against the armature 62, in particular the armature rod 65, so that the movement of the armature 62 and the movement of the sliding plunger are coupled at least in the case of movement of the armature 62 in the direction of the sliding plunger. In a closed position of the pilot valve, the sliding plunger preferably lies against a pilot-valve seat in such a way that no fluid flows between the pilot control chamber of the main valve and the pilot working chamber 26.

During operation of the damping-valve device 54, in the case of a movement of the piston rod 20 in the compression direction D, the hydraulic fluid flows into the optional comfort valve into the compression main control chamber, wherein, due the pressure in the compression main control chamber, the main piston is subjected to an opening force and is moved axially upward. In the process, the main piston lifts off from the main-valve seat and the hydraulic fluid flows through the main flow channel to the rebound main control chamber. At the same time, a partial stream of the hydraulic fluid flows into the pilot control chamber and subjects the main piston to a closing force in the direction of the main-valve seat. The closing force determines the opening width of the main valve, in particular the cross section of the main flow channel, which determines the damping force of the damping-valve device 54. The pressure in the pilot control chamber is set by the pilot valve, wherein the hydraulic fluid flows from the pilot control chamber into the pilot working chamber 26, which is opened up by the sliding plunger. The axial position of the sliding plunger is set, in particular predefined, by means of a magnet coil 54. In the closed position of the pilot valve, the sliding plunger closes off the pilot working chamber 26 preferably completely, so that the hydraulic pressure in the pilot control chamber increases to a maximum value and the main valve is closed and is preferably subjected to a force in the closing direction in that the main piston is pressed onto the main valve seat.

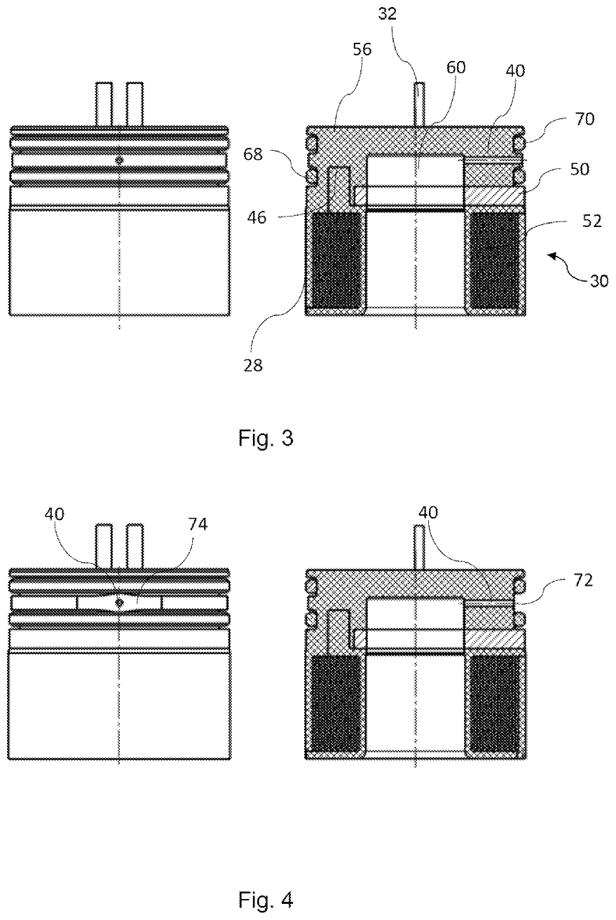

FIG. 3 shows the coil unit 30 and the separating element 56 in a perspective view and in a longitudinal sectional view. The separating element 56 is by way of example configured to be hollow cylindrical with a cylinder base. Preferably, the hollow-cylindrical separating element 56 is configured to be open in the direction of the coil 52. Arranged within the separating element 56 is the armature chamber 60, which is delimited at least partially by the separating element 56. The separating element 56 preferably has a radial fluid channel 40 which is arranged and configured for at least partial or complete venting of the armature chamber 60. Preferably, the armature chamber 60 is filled at least partially with a gas, in particular air, and partially with hydraulic fluid. The gas is arranged in particular at the upper end, pointing in the rebound direction, of the armature chamber 60. Preferably, the fluid channel 40 extends exclusively in a radial direction and opens out into the armature chamber 60 in particular at the upper end, pointing in the rebound direction, of said armature chamber. The separating element 56 preferably has a connecting region 46 which lies against the coil carrier 28. The connecting region 46 preferably extends only over a sub-portion of the separating element 56. A flux plate 50 is preferably arranged between the coil 52, in particular the coil carrier 28, and the separating element 56. The flux plate 50 is in particular of circular-ring-disk-shaped form and is preferably formed completely or partially from a metallic, in particular magnetically permeable or magnetizable material. The flux plate 50 preferably lies directly against the separating element 56 and against the coil carrier 28.

The separating element 56 is formed in particular from a plastic. The separating element 56 is preferably produced by means of an injection-molding process. Arranged circumferentially around the separating element 56 are in particular two sealing rings 68, 70 which lie against the separating element 56 and against the inner side of the damping-valve housing 45. The outer diameter of the separating element 56 is preferably smaller than or corresponds to the inner diameter of the damping-valve housing 45, so that the separating element 56 lies against the damping-valve housing 45 or a small gap is formed between the damping-valve housing 45 and the separating element 56. In particular, the separating element 56 has on its outer circumference two circumferentially extending grooves in which in each case one of the sealing rings 68, 70 is arranged. The fluid channel 40 preferably extends between the sealing rings 68, 70. The fluid channel 40 preferably opens out at the circumferential outer surface of the separating element 56 at a position between the two sealing rings 68, 70. By way of example, the sealing rings 68, 70 are of identical form and are arranged in particular so as to be coaxial with one another. Preferably, provision is made in the damping-valve housing 45 of a bore 58 which is arranged so as to be aligned with the fluid channel 40 and is connected fluidically to the latter.

The bore 58 in the damping-valve housing 45 preferably has a smaller diameter than the fluid channel 40 in the separating element 56. In particular, the fluid channel 40 has a diameter which corresponds to 1.5 to 5 times, in particular 2 to 3 times, the diameter of the bore 58. In particular, the fluid channel has a round, polygonal, quadrilateral, rectangular, square, circular or elliptical cross section.

During operation of the damping-valve device 54 in the compression stage, a hydraulic fluid preferably flows from the pilot working chamber 26 through the interior of the tubular armature rod 65 into the armature chamber 60, and then through the fluid channel 40 and the bore 58 into the first working chamber. The armature chamber 60 is preferably connected fluidically to the first working chamber 22 via the bore 58 and the fluid channel 40.

The separating element 56 is preferably connected fixedly, in particular bonded substance-to-substance, to the coil carrier 28. The separating element 56 is preferably connected to the coil carrier 28 by means of an injection-molding process. The separating element 56 is in particular molded onto the coil carrier 28, preferably around the coil carrier 28, by means of an injection molding process. The separating element 56 is in particular connected fixedly, preferably bonded substance-to-substance, to the flux plate 50. Preferably, the separating element 56 is connected to the flux plate 50 by means of an injection-molding process and is in particular molded onto the flux plate.

FIG. 4 shows a further exemplary embodiment of a coil unit 30, which corresponds for the most part to the coil unit 30 in FIGS. 2 and 3, with the difference that the separating element 56 in FIG. 4 has a clearance 72 formed at the outer side of the separating element 56. Preferably, the clearance 72 is at the outer-side mouth of the fluid channel 40. The clearance 72 is arranged in particular between the two sealing rings 68, 70 and preferably forms a fluid chamber 74 which is arranged between the bore 58 and the fluid channel 40.

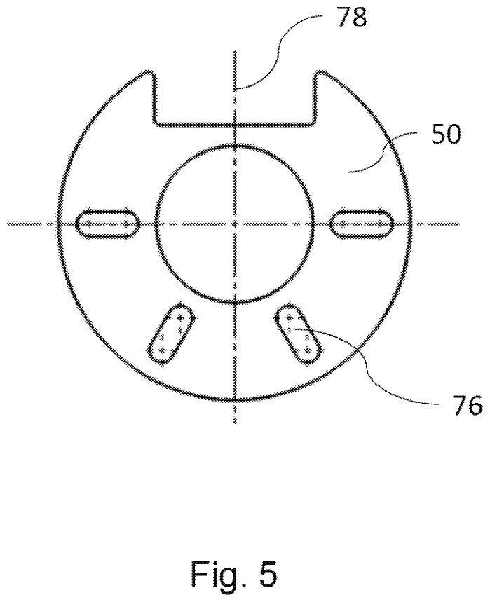

FIG. 5 shows an exemplary embodiment of a flux plate 50. The flux plate is preferably formed from a steel and lies in particular against the damping-valve housing 45. The flux plate 50 preferably has a plurality of, for example four, cutouts 76 which extend in particular completely axially through the thickness of the flux plate 50 and which, by way of example, are in the form of slots. Preferably, the cutouts 76 serve for fastening of the flux plate 50 to the separating element 56, which is molded onto the flux plate 50 by means of an injection-molding process. The flux plate 50 has by way of example at its outer circumference a recess 78 which, by way of example, is of rectangular form. The coil carrier 28 preferably has an axial projection which extends along the recess 78 and which, for example, serves for mounting of the coil carrier 28.

### LIST OF REFERENCE SIGNS

10 Vibration damper
12 Outer tube
14 Inner tube
16 Compensation chamber
18 Working piston
20 Piston rod
22 First/piston-rod-side working chamber
24 Second/piston-rod-remote working chamber
26 Pilot working chamber
28 Coil carrier
30 Coil unit
32 Contact element
34 Closure package
36 Base piece
38 Base valve
40 Fluid channel
42 Spring element
44 Housing top part
45 Damping-valve housing
46 Connecting region
48 Drive region
50 Flux plate
52 Coil
54 Damping-valve device
56 Separating element
58 Bore
60 Armature chamber
62 Armature
64 Pole tube
65 Armature rod
68 Sealing ring
70 Sealing ring
72 Clearance
74 Fluid chamber
76 Cutout
78 Recess

1. A vibration damper of a motor vehicle, comprising:
an outer tube and an inner tube arranged so as to be coaxial therewith;
a working piston which is arranged so as to be axially movable within the inner tube and which divides the interior space of the inner tube into a piston-rod-side working chamber and a piston-rod-remote working chamber; and
a damping-valve device which is arranged in the working piston, wherein the damping-valve device includes:
a damping-valve housing;
a coil unit which is arranged within the damping-valve housing and which has a coil carrier and a coil wound thereon;
a separating element for separating hydraulic oil and gas within the coil unit and/or damping-valve housing; and
an armature chamber which is arranged within the coil unit and in which an axially movable armature is arranged;
wherein the separating element is formed from a plastic.

2. The vibration damper as claimed in claim 1, wherein the separating element is produced by an injection-molding process.

3. The vibration damper as claimed in claim 1, wherein the separating element has a fluid channel which extends in a radial direction and which has a round or polygonal cross section and which is connected fluidically to the armature chamber.

4. The vibration damper as claimed in claim 3, wherein the damping-valve housing has a bore which extends in the radial direction and which is connected fluidically directly to the fluid channel, and wherein the diameter of the fluid channel is smaller than the diameter of the bore.

5. The vibration damper as claimed in claim 4, wherein the diameter of the fluid channel corresponds to 1.5 to 5 times the diameter of the bore.

6. The vibration damper as claimed in claim 4, wherein the diameter of the fluid channel corresponds to 2 to 3 times the diameter of the bore.

7. The vibration damper as claimed in claim 4, wherein a fluid chamber is arranged between the bore and the fluid channel and is formed by a clearance in the separating element.

8. The vibration damper as claimed in claim 1, wherein the separating element is bonded substance-to-substance to the coil carrier.

9. The vibration damper as claimed in claim 1, wherein the separating element is connected to the coil carrier by an injection-molding process.

10. The vibration damper as claimed in claim 1, wherein a flux plate is arranged between the coil carrier and the separating element.

11. The vibration damper as claimed in claim 10, wherein the flux plate is formed from a magnetic or magnetizable material.

12. The vibration damper as claimed in claim 10, wherein the separating element is connected to the flux plate by an injection-molding process.

13. The vibration damper as claimed in claim 1, wherein arranged circumferentially around the separating element are two sealing rings which lie against the separating element and against the inner side of the damping-valve housing, and wherein the fluid channel is arranged between the sealing rings.
